(19) United States
(12) Patent Application Publication
(10) Pub. No.: US 2025/0119810 A1
(43) Pub. Date: Apr. 10, 2025

(54) FAILURE OF A SERVING CELL IN A MULTIPLE TRANSMISSION RECEPTION POINT SYSTEM

(71) Applicant: Nokia Technologies Oy, Espoo (FI)

(72) Inventors: Halit Murat GÜRSU, Munich (DE); Alperen GUNDOGAN, Munich (DE); Ahmad AWADA, Munich (DE); Subramanya CHANDRASHEKAR, Bangalore (IN); Panagiotis SPAPIS, Munich (DE)

(21) Appl. No.: 18/294,860

(22) PCT Filed: Jun. 20, 2022
(86) PCT No.: PCT/EP2022/067876

§ 371 Date: Feb. 2, 2024

(30) Foreign Application Priority Data
Aug. 5, 2021 (IN) 202141035355

(51) Int. Cl. H04W 36/30; H04W 76/15

(52) U.S. Cl. CPC H04W 36/305; H04W 76/15

(57) ABSTRACT

An apparatus, comprising at least one processor, and at least one memory storing instructions, the at least one memory and the instructions configured to, with the at least one processor, cause a terminal device to detect a failure, related to a serving cell and to transmit a first indication characterizing the failure to a network node associated with the assisting cell.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment (UE), and one or more network devices such as e.g. base stations.

In some communications systems, inter-cell Multiple Transmission Reception Point, mTRP, is provided, wherein a UE may transmit and/or receive user plane data and/or control plane data from one or multiple cells. In some mTRP systems, a UE may have one serving cell which may e.g. provide common channels such as paging, and which may serve as an anchor cell for the UE. Additionally, at least one assisting cell may be provided in some mTRP systems, wherein the UE can (also) exchange data with the at least one assisting cell over its radio link.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some exemplary embodiments relate to an apparatus, comprising at least one processor, and at least one memory storing instructions, the at least one memory and the instructions configured to, with the at least one processor, cause a terminal device to detect a failure related to a serving cell and to transmit a first indication characterizing the failure to a network node associated with an assisting cell.

In some embodiments, the apparatus may be an apparatus for a wireless communications system.

In some embodiments, the apparatus or its functionality, respectively, may be provided in a terminal device, for example user equipment (UE), of the communications system.

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the failure detected by the terminal device may be a radio link failure, RLF, e.g. according to some accepted standards, related to its serving cell.

In some embodiments, the terminal device may be configured, for example by a central unit control plane, CU-CP, to report the radio link failure related to its serving cell, e.g. using the first indication, via the assisting cell, e.g. to a distributed unit providing the assisting cell.

In some embodiments, the assisting cell may be provided by a distributed unit, e.g. of a network node such as a gNB. Insofar, in some embodiments, the first indication may be transmitted to the distributed unit associated with, e.g. providing the, assisting cell.

In some embodiments, a medium access control, MAC, message or MAC control element, MAC CE, may be used for reporting the radio link failure. Alternatively or additionally, in some embodiments, a radio resource control, RRC, message may be used for reporting the radio link failure.

In some embodiments, the instructions, when executed by the at least one processor, further cause the terminal device to: perform at least one measurement related to at least one potential target cell, and, optionally, to transmit the first indication based on the at least one measurement. In some embodiments, the at least one measurement is a layer 1 (L1) measurement.

In some embodiments, the terminal device may measure at least one potential target cell, and may decide, based on the at least one measurement, how to transmit the first indication associated with the radio link failure.

In some embodiments, the terminal device may skip, i.e. omit, performing a conventional re-establishment procedure, for example an RRC re-establishment procedure according to some accepted standard, e.g. after detecting the failure, e.g. RLF. Instead, in some embodiments, e.g. after detecting the failure, e.g. RLF, the terminal device may, optionally, perform the at least one measurement related to at least one potential target cell, and may transmit the first indication characterizing the failure to an assisting cell. In some embodiments, this enables to attain a faster (link) establishment, e.g. after an RLF in an mTRP configuration.

In some embodiments, the instructions, when executed by the at least one processor, further cause the terminal device to receive configuration information characterizing at least one of: a) a configuration of at least one assisting cell for multiple Transmission Reception Point, TRP, transmission/reception, b) an indication for the terminal device to enable a link failure recovery by sending a medium access control, MAC, message (or MAC control element, MAC CE), for example as the first indication, indicating the failure to a distributed unit associated with the assisting cell, c) an indication for the terminal device to enable radio link failure recovery by sending a radio resource control, RRC, message, for example as the first indication, for example using an assisting cell radio link, indicating the failure to a central unit associated with the serving cell, d) an indication for the terminal device to enable a link failure recovery by sending, for example as the first indication, a MAC message indicating the failure to a distributed unit associated with the assisting cell and an RRC message indicating the failure to a central unit.

In some embodiments, the terminal device may report the serving cell failure, e.g. radio link failure, RLF, for example only using an uplink, UL, MAC CE, for example if the measurements of the terminal device indicate a target cell with an mTRP preconfiguration. In some embodiments, a layer-1 reference signal received power, L1-RSRP, report may also be sent by the terminal device, e.g. within the first indication.

In some embodiments, if the measurements of the terminal device indicate a target cell without mTRP preconfiguration, the terminal device may report the serving cell RLF using an RRC message, which, in some embodiments, may include (further) measurement reports, for example at least one layer-3 (L3) measurement, e.g. in addition to the MAC CE and the L1-RSRP measurement report(s).

In some embodiments, a distributed unit (DU) associated with the assisting cell can check whether the target cell is a part of the same DU, for example based on the measurement report received from the terminal device, and may decide the next course of action based on an outcome of this check.

In some embodiments, the instructions, when executed by the at least one processor, further cause the terminal device to perform at least one of: a) sending a medium access control, MAC, message indicating the failure to a distributed unit associated with the assisting cell, b) receiving a MAC message to activate a RRC configuration of a target cell to actuate a, for example layer 1 based, serving cell change.

In some embodiments, the instructions, when executed by the at least one processor, further cause the terminal device to perform at least one of: a) sending a radio resource control, RRC, message indicating the failure to a central unit associated with the serving cell, b) receiving a handover command, for example a layer 3 handover command to perform a handover to a target cell. In some embodiments, the RRC message may be sent to the distributed unit providing the assisting cell, e.g. for forwarding the RRC message to the central unit.

In some embodiments, the instructions, when executed by the at least one processor, further cause the terminal device to perform at least one of: sending a MAC message indicating the failure to a distributed unit associated with the assisting cell, b) receiving a request from the distributed unit associated with the assisting cell to transmit a radio link failure report, c) transmitting radio link failure report to a central unit associated with the serving cell, d) receiving a handover command.

In some embodiments, one or more of the following exemplary cases may be considered:

Case 1: In some embodiments, it is assumed that the terminal device, e.g. UE, has an mTRP preconfiguration, e.g. for at least one measured/selected target cell for recovery. In some embodiments, if an RRC configuration of the potential target cell (for example preconfiguration) is already available to the UE, the target cell may be eligible for a L1/L2 handover. In some embodiments, the distributed unit may send a MAC CE message to the UE, e.g. to activate an RRC configuration of the target cell, e.g. to actuate a serving cell change. In some embodiments, the distributed unit may notify a central unit about an L1/L2 handover, e.g. due to the RLF of the serving cell.

Case 2: In some embodiments, the UE may not have an mTRP preconfiguration for a measured/selected target cell for recovery. In some embodiments, the UE may report to the central unit a RLF Report+L3 measurement, e.g. in an RRC message, e.g. after the RLF, e.g. via the DU. In some embodiments, the DU may forward the UE's RRC message (e.g., the RLF report), to the CU. In some embodiments, the CU may prepare an inter-DU serving cell change with one of the existing mobility solutions (for example, conditional handover, CHO, according to some accepted standards, or L1/L2 mobility, or legacy handover).

Case 3: In some embodiments, the UE may have an mTRP preconfiguration for the measured/selected target cell for recovery, but maybe belonging to a different DU. In this case, in some embodiments, first L1 RSRP measurements along with the RLF indication may be sent by the UE to the DU e.g. using MAC CE, e.g. similar to Case 1 explained above. In some embodiments, the DU may verify that there is no mTRP eligible target cell in the L1 RSRP report, and hence may ask the UE to send the RLF report and, optionally, latest measurements in the RRC message, e.g. by using a downlink, DL, MAC CE. In some embodiments, this will be delivered to a control plane, CP, of the CU, CU-CP, for further action. In some embodiments, the CU-CP may initiate an inter-DU target cell handover using a L3 handover command according to some accepted standard or may provide the DU with necessary information to actuate an inter-DU L1/L2 handover.

In one option, the network can configure the UE to send the RLF report directly to the CU associated with the serving cell, for example even when the UE has an mTRP preconfiguration for the measured/selected target cell for recovery. In some embodiments, this may work as in Case 2 explained above.

In some embodiments, the following may be noted regarding measured/selected target cell(s) for recovery: In some embodiments, there may be a single selected cell by the UE (e.g., post RLF) to perform RLF recovery. In some other embodiments, there may be more than one measured cell for recovery, out of which one is a potential target cell.

In some embodiments, the mTRP preconfiguration may include both options, e.g. a) to configure a cell in assisting cell mode as may e.g. be required for mTRP operation, and b) configuration needed to perform an inter-cell change with a L1/L2 handover method.

Further exemplary embodiments relate to a method, comprising: detecting, by a terminal device, a failure related to a serving cell, and transmitting a first indication characterizing the failure to a network node associated with an assisting cell.

Further exemplary embodiments relate to an apparatus comprising means for causing a terminal device to detect a failure related to a serving cell and to transmit a first indication characterizing the failure to a network node associated with an assisting cell.

Further exemplary embodiments relate to an apparatus, comprising at least one processor, and at least one memory storing instructions, the at least one memory and the instructions configured to, with the at least one processor, cause a distributed unit providing an assisting cell to: receive a first indication from a terminal device, the first indication characterizing a failure related to a serving cell of the terminal device.

In some embodiments, the instructions, when executed by the at least one processor, further cause the distributed unit to perform at least one of: a) receiving a medium access control, MAC, message indicating the failure from the terminal device, b) sending a MAC message to activate a RRC configuration of a target cell to actuate a serving cell change to the terminal device.

In some embodiments, the instructions, when executed by the at least one processor, further cause the distributed unit to perform at least one of: a) receiving a radio resource control, RRC, message indicating the failure from the terminal device and forwarding the RRC message to a central unit, e.g. the central unit associated with the serving cell, b) sending a handover command, for example a layer 3 handover command received from the central unit, to the terminal device.

In some embodiments, the instructions, when executed by the at least one processor, further cause the distributed unit to perform at least one of: a) receiving a MAC message indicating the failure from the terminal device, b) transmitting a request to the terminal device to transmit a radio link failure report, c) receiving a radio link failure report, for example in a radio resource control, RRC, message, from the terminal device and forwarding the RRC radio link failure report to a central unit, e.g. the central unit associated with the serving cell, d) transmitting a handover command, e.g. a layer 3 handover command received from the central unit, to the terminal device.

Further exemplary embodiments relate to a method comprising: receiving, by a distributed unit providing an assisting cell, a first indication from a terminal device, the first indication characterizing a failure related to a serving cell of the terminal device.

Further exemplary embodiments relate to an apparatus comprising means for causing a distributed unit providing an assisting cell to receive a first indication from a terminal device, the first indication characterizing a failure related to a serving cell of the terminal device.

Further exemplary embodiments relate to an apparatus, comprising at least one processor, and at least one memory storing instructions, the at least one memory and the instructions configured to, with the at least one processor, cause a network device to provide configuration information to a terminal device, the configuration information characterizing at least one of: a) a configuration of at least one assisting cell for multiple Transmission Reception Point, TRP, transmission/reception, b) an indication for the terminal device to enable a link failure recovery by sending a medium access control, MAC, message indicating a failure to a distributed unit associated with the assisting cell, c) an indication for the terminal device to enable radio link failure recovery by sending a radio resource control, RRC, message indicating the failure to a central unit associated with the assisting cell, d) an indication for the terminal device to enable a radio link failure recovery by sending a MAC message indicating the failure to a distributed unit associated with the assisting cell and an RRC message using the assisting cell radio link, indicating the failure to a central unit associated with the serving cell.

Further exemplary embodiments relate to a method, comprising: providing, by a network device, configuration information to a terminal device, the configuration information characterizing at least one of: a) a configuration of at least one assisting cell for multiple Transmission Reception Point, TRP, transmission/reception, b) an indication for the terminal device to enable a link failure recovery by sending a medium access control, MAC, message indicating a failure to a distributed unit, c) an indication for the terminal device to enable radio link failure recovery by sending a radio resource control, RRC, message indicating the failure to a central unit, d) an indication for the terminal device to enable a link failure recovery by sending a MAC message indicating the failure to a distributed unit and an RRC message indicating the failure to a central unit.

Further exemplary embodiments relate to an apparatus comprising means for causing a network device to provide configuration information to a terminal device, the configuration information characterizing at least one of: a) a configuration of at least one assisting cell for multiple Transmission Reception Point, TRP, transmission/reception, b) an indication for the terminal device to enable a radio link failure recovery by sending a medium access control, MAC, message indicating a failure to a distributed unit associated with the assisting cell, c) an indication for the terminal device to enable radio link failure recovery by sending a radio resource control, RRC, message using the assisting cell radio link, indicating the failure to a central unit associated with the serving cell, d) an indication for the terminal device to enable a radio link failure recovery by sending a MAC message indicating the failure to a distributed unit associated with the assisting cell and an RRC message indicating the failure to a central unit associated with the serving cell.

Further exemplary embodiments relate to a wireless communications system comprising at least one apparatus according to the embodiments.

### BRIEF DESCRIPTION OF THE FIGURES

FIG. 1 schematically depicts a simplified block diagram of an apparatus according to some embodiments,

FIG. 2 schematically depicts a simplified block diagram of an apparatus according to some embodiments,

FIG. 3 schematically depicts a simplified block diagram according to some embodiments,

FIG. 4 schematically depicts a simplified flow chart according to some embodiments,

FIG. 5 schematically depicts a simplified flow chart according to some embodiments,

FIG. 6 schematically depicts a simplified block diagram according to some embodiments,

FIG. 7 schematically depicts a simplified flow chart according to some embodiments,

FIG. 8 schematically depicts a simplified flow chart according to some embodiments,

FIG. 9 schematically depicts a simplified flow chart according to some embodiments,

FIG. 10 schematically depicts a simplified flow chart according to some embodiments,

FIG. 11 schematically depicts a simplified flow chart according to some embodiments,

FIG. 12 schematically depicts a simplified flow chart according to some embodiments,

FIG. 13 schematically depicts a simplified flow chart according to some embodiments,

FIG. 14 schematically depicts an exemplary signalling diagram according to some embodiments,

FIG. 15 schematically depicts a simplified block diagram according to some embodiments,

FIG. 16 schematically depicts a simplified block diagram according to some embodiments,

FIG. 17 schematically depicts a simplified block diagram according to some embodiments,

FIG. 18 schematically depicts a simplified block diagram according to some embodiments, and

FIG. 19 schematically depicts a simplified flow chart according to some embodiments.

### DESCRIPTION OF SOME EXEMPLARY EMBODIMENTS

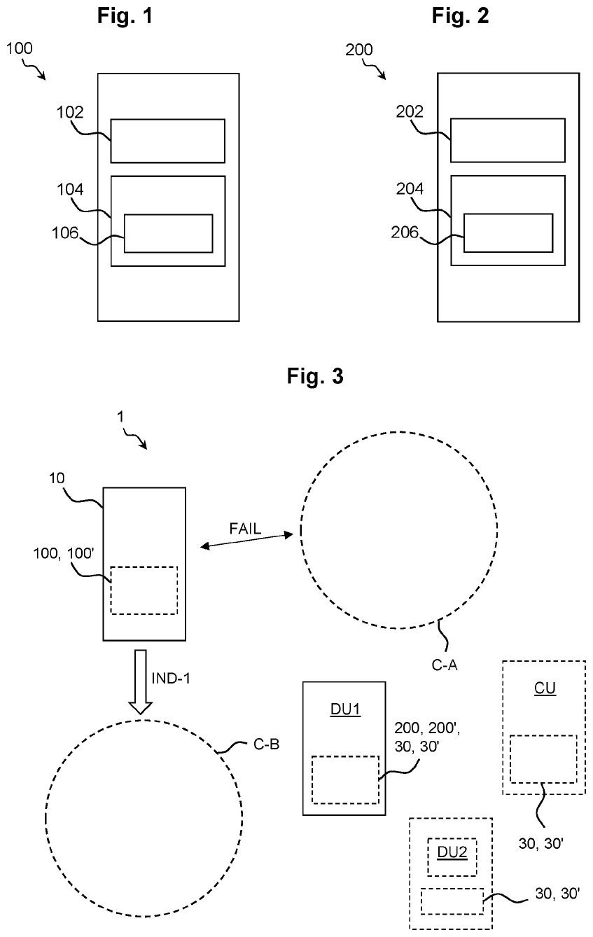

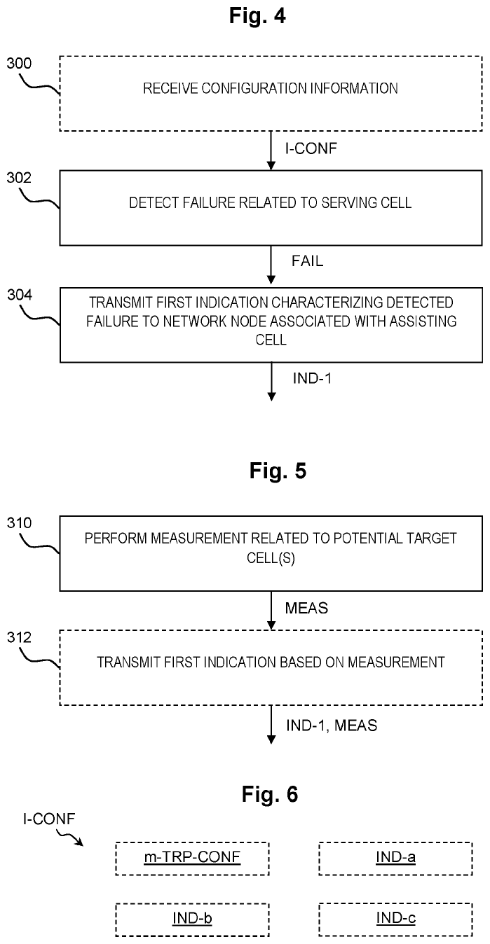

Some exemplary embodiments, see for example FIG. 1, 3, 4, relate to an apparatus 100 comprising at least one processor 102, and at least one memory 104 storing instructions 106, the at least one memory 104 and the instructions 106 configured to, with the at least one processor 102, cause a terminal device 10 (FIG. 3) to detect 302 (FIG. 4) a failure FAIL related to a serving cell C-A, e.g. a radio cell C-A, which is currently serving the terminal device 10, and to transmit 304 a first indication IND-1 characterizing the failure to a network node associated with an assisting cell C-B.

In some embodiments, the apparatus 100 (FIG. 1) may be an apparatus for a wireless communications system 1 (FIG. 3). In some embodiments, the apparatus 100 or its functionality, respectively, may be provided in a terminal device, for example user equipment (UE), 10 of the communications system 1.

In some embodiments, the apparatus 100 according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the communications system 1 is capable of inter-cell Multiple Transmission Reception Point, mTRP, transmission and/or reception, wherein the UE 10 may transmit and/or receive user plane data and/or control plane data from one or multiple cells C-A, C-B. In the present example, the cell C-A is a serving cell, and the cell C-B is an assisting cell of the mTRP configuration.

In some embodiments, the failure FAIL detected by the terminal device 10 may be a radio link failure, RLF, e.g. according to some accepted standards, related to its serving cell C-A.

In some embodiments, the terminal device 10 may be configured, for example by a central unit control plane, CU-CP (not shown), to report the radio link failure FAIL related to its serving cell C-A, e.g. using the first indication IND-1, via the assisting cell C-B, e.g. to a distributed unit DU1 providing the assisting cell C-B.

In some embodiments, a medium access control, MAC, message or MAC control element, MAC CE, may be used for reporting the radio link failure. Alternatively or additionally, in some embodiments, a radio resource control, RRC, message may be used for reporting the radio link failure. In some embodiments, FIG. 5, the instructions 106, when executed by the at least one processor 102, further cause the terminal device 10 to: perform 310 at least one layer 1 measurement MEAS related to at least one potential target cell, and, optionally, to transmit 312 the first indication IND-1 based on the at least one measurement MEAS. In some embodiments, at least a part of the at least one measurement MEAS may also be transmitted 312 together with or within the first indication IND-1.

In some embodiments, the terminal device 10 may measure 310 at least one potential target cell, and may decide, based on the at least one measurement MEAS, how to transmit the first indication IND-1 associated with the radio link failure FAIL.

In some embodiments, the terminal device 10 may skip, i.e. omit, performing a conventional re-establishment procedure, for example an RRC re-establishment procedure according to some accepted standard, e.g. after detecting 302 (FIG. 4) the failure FAIL, e.g. RLF. Instead, in some embodiments, e.g. after detecting 302 the failure FAIL, e.g. RLF, the terminal device 10 may, optionally, perform 310 (FIG. 5) the at least one measurement MEAS related to at least one potential target cell, and may transmit 312 the first indication IND-1 characterizing the failure FAIL to an assisting cell C-B (FIG. 3). In some embodiments, this enables to attain a faster (link) establishment or re-establishment, e.g. after an RLF in an mTRP configuration, e.g. as compared to some conventional approaches.

In some embodiments, FIG. 4, 6, the instructions 106, when executed by the at least one processor 102, further cause the terminal device 10 to receive 300 configuration information I-CONF characterizing at least one of: a) a configuration m-TRP-CONF (FIG. 6) of at least one assisting cell C-B (FIG. 3) for multiple Transmission Reception Point, TRP, transmission/reception, b) an indication IND-a (FIG. 6) for the terminal device 10 to enable a link failure recovery by sending a medium access control, MAC, message (or MAC control element, MAC CE), for example as the first indication IND-1, indicating the failure FAIL to a distributed unit DU1 associated with the assisting cell C-B, c) an indication IND-b for the terminal device 10 to enable radio link failure recovery by sending a radio resource control, RRC, message, for example using an existing radio link with the assisting cell C-B, for example as the first indication IND-1, indicating the failure FAIL to a central unit CU (FIG. 3) associated with the serving cell C-A, d) an indication IND-c for the terminal device 10 to enable a link failure recovery by sending, for example as the first indication IND-1, a MAC message indicating the failure FAIL to a distributed unit DU1 associated with the assisting cell C-B and an RRC message using the assisting cell radio link indicating the failure FAIL to a central unit CU associated with the serving cell C-A.

In some embodiments, the terminal device 10 (FIG. 3) may report the serving cell failure FAIL, e.g. radio link failure, RLF, for example only using an uplink, UL, MAC CE, for example if the measurements MEAS (FIG. 5) of the terminal device 10 indicate a target cell with an mTRP preconfiguration. In some embodiments, a layer-1 reference signal received power, L1-RSRP, report may also be sent by the terminal device 10, e.g. within the first indication IND-1.

In some embodiments, if the measurements MEAS of the terminal device 10 indicate a target cell without mTRP preconfiguration, the terminal device 10 may report the serving cell RLF using an RRC message, which, in some embodiments, may include (further) measurement reports, for example at least one layer-3 (L3) measurement, e.g. in addition to the MAC CE and the L1-RSRP measurement report(s).

In some embodiments, a distributed unit DU1 (FIG. 3) associated with the assisting cell C-B can check whether the target cell is a part of the same DU1, for example based on the measurement report received from the terminal device 10, and may decide the next course of action based on an outcome of this check.

In some embodiments, FIG. 7, the instructions 106, when executed by the at least one processor 102, further cause the terminal device 10 to perform at least one of: a) sending 320 a medium access control, MAC, message MAC-MSG-FAIL indicating the failure FAIL to a distributed unit associated with the assisting cell C-B, b) receiving 322 a MAC message MAC-MSG-HO to activate a RRC configuration of a target cell to actuate a, for example layer 1 based, serving cell change.

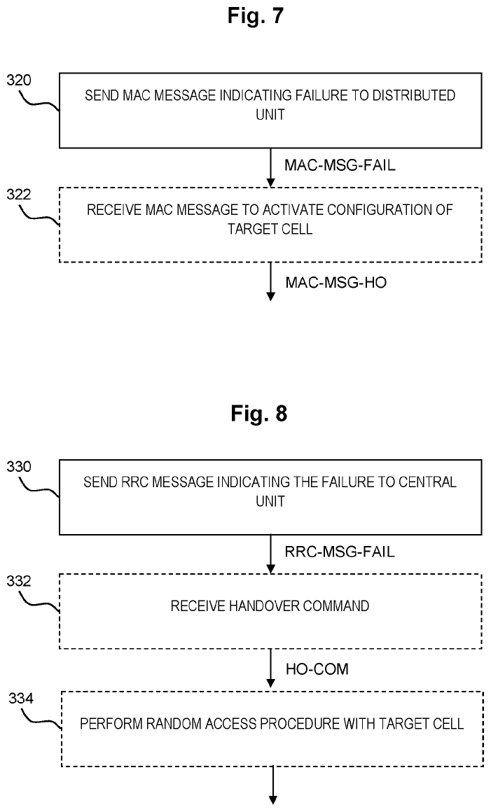

In some embodiments, FIG. 8, the instructions 106, when executed by the at least one processor 102, further cause the terminal device 10 to perform at least one of: a) sending 330 a radio resource control, RRC, message RRC-MSG-FAIL indicating the failure FAIL to a central unit CU associated with the serving cell C-A using the assisting cell radio link, b) receiving 332 a, for example layer 3, handover command HO-COM to perform handover to a target cell. In some embodiments, the RRC message RRC-MSG-FAIL may be sent to the distributed unit DU1 providing the assisting cell C-B, e.g. for forwarding the RRC message RRC-MSG-FAIL to the central unit CU.

In some embodiments, after receiving the handover command HO-COM, the terminal device 10 may perform a random access procedure with the target cell.

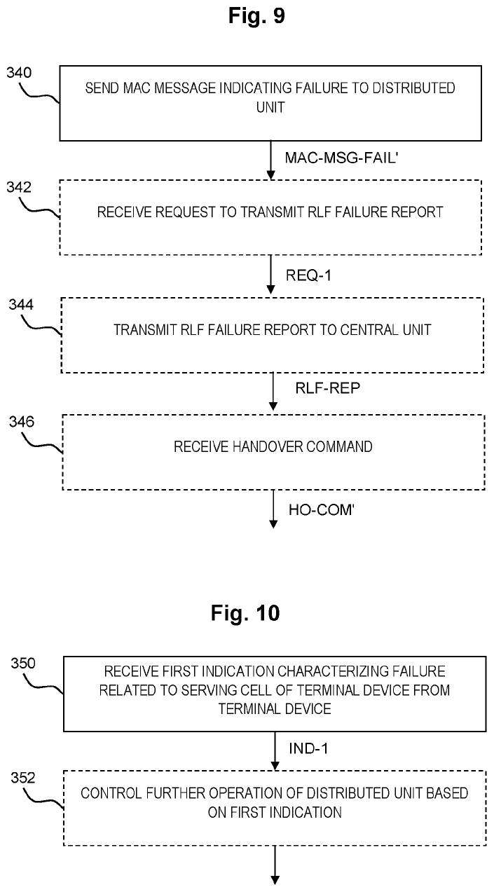

In some embodiments, FIG. 9, the instructions 106, when executed by the at least one processor 102, further cause the terminal device 10 to perform at least one of: sending 340 a MAC message MAC-MSG-FAIL′ indicating the failure FAIL to a distributed unit DU1 associated with the assisting cell C-B, b) receiving 342 a request REQ-1 from the distributed unit DU1 to transmit a radio link failure report RLF-REP to a central unit CU associated with the serving cell C-A, c) transmitting 344 the radio link failure report RLF-REP to a central unit CU, d) receiving 346 a handover command HO-COM′ to perform a handover to a target cell.

In some embodiments, one or more of the following exemplary cases may be considered:

Case 1: In some embodiments, it is assumed that the terminal device, e.g. UE, 10 (FIG. 3) has an mTRP preconfiguration, e.g. for at least one measured/selected target cell for recovery. In some embodiments, if an RRC configuration of the potential target cell (for example preconfiguration) is already available to the UE 10, the target cell may be eligible for a L1/L2 handover. In some embodiments, the distributed unit DU1 may send a MAC CE message to the UE 10, e.g. to activate an RRC configuration of the target cell, e.g. to actuate a serving cell change. In some embodiments, the distributed unit DU1 may notify a central unit CU about an L1/L2 handover, e.g. due to the RLF of the serving cell C-A.

Case 2: In some embodiments, the UE 10 may not have an mTRP preconfiguration for a measured/selected target cell for recovery. In some embodiments, the UE 10 may report to the central unit CU a RLF Report+L3 measurement, e.g. in an RRC message, e.g. after the RLF, e.g. via the distributed unit DU1. In some embodiments, the distributed unite DU1 may forward the UE's RRC message (e.g., the RLF report), to the central unit CU. In some embodiments, the central unit CU may prepare an inter-DU serving cell change with one of the existing mobility solutions (for example, conditional handover, CHO, according to some accepted standards, or L1/L2 mobility, or legacy handover).

Case 3: In some embodiments, the UE 10 may have an mTRP preconfiguration for the measured/selected target cell for recovery, but maybe belonging to a different DU. In this case, in some embodiments, first L1 RSRP measurements along with the RLF indication may be sent by the UE 10 to the DU e.g. using MAC CE, e.g. similar to Case 1 explained above. In some embodiments, the DU may verify that there is no mTRP eligible target cell in the L1 RSRP report, and hence may ask the UE 10 to send the RLF report and, optionally, latest measurements in the RRC message, e.g. by using a downlink, DL, MAC CE. In some embodiments, this may be delivered to a control plane, CP, of the central unit CU,

CU-CP, for further action. In some embodiments, the CU-CP may initiate an inter-DU target cell handover using a L3 handover command according to some accepted standard or may provide the DU with necessary information to actuate an inter-DU L1/L2 handover.

In one option, the network 1 (FIG. 3) can configure the UE 10 to send the RLF report directly to the central unit CU, for example even when the UE 10 has an mTRP preconfiguration for the measured/selected target cell for recovery. In some embodiments, this may work as in Case 2 explained above.

In some embodiments, the following may be noted regarding measured/selected target cell(s) for recovery: In some embodiments, there may be a single selected cell by the UE 10 (e.g., post RLF) to perform RLF recovery. In some other embodiments, there may be more than one measured cell for recovery, out of which one is a potential target cell.

In some embodiments, the mTRP preconfiguration may include both options, e.g. a) to configure a cell in assisting cell mode as may e.g. be required for mTRP operation, e.g. similar to the cell C-B of FIG. 3, and b) configuration needed to perform an inter-cell change with a L1/L2 handover method.

Further exemplary embodiments, FIG. 4, relate to a method, comprising: detecting, by a terminal device 10, a failure FAIL related to a serving cell C-A, and transmitting a first indication IND-1 characterizing the failure FAIL to a network node DU1 associated with the assisting cell C-B.

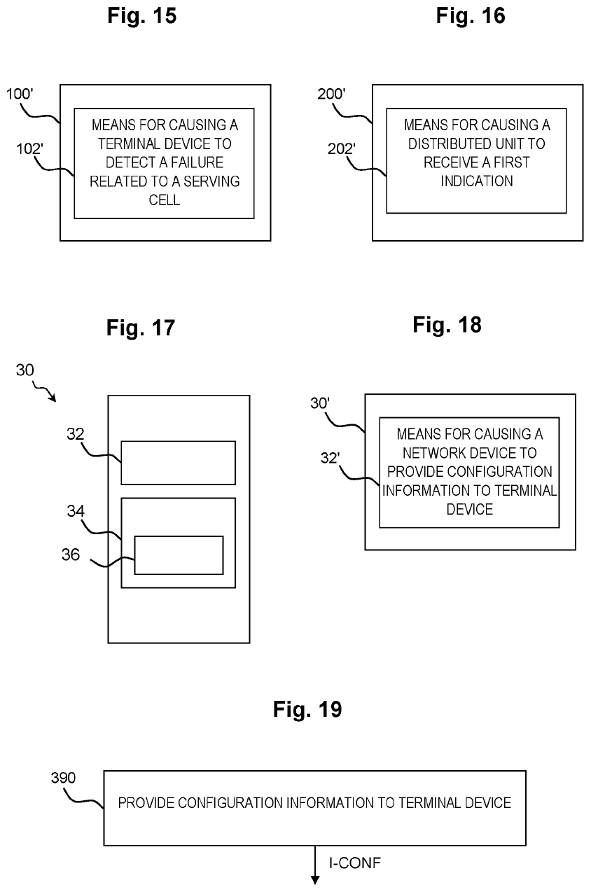

Further exemplary embodiments, FIG. 15, relate to an apparatus 100 comprising means 102′ for causing a terminal device 10 to detect 302 a failure FAIL related to a serving cell C-A and to transmit 304 a first indication IND-1 characterizing the failure FAIL to a network node DU1 associated with the assisting cell C-B. In some embodiments, the means 102′ may comprise at least one of the components 102, 104, 106 of FIG. 1.

Further exemplary embodiments, FIG. 2, 3, 10, relate to an apparatus 200, comprising at least one processor 202, and at least one memory 204 storing instructions 206, the at least one memory 204 and the instructions 206 configured to, with the at least one processor 202, cause a distributed unit (DU) DU1 providing an assisting cell C-B to: receive 350 (FIG. 10) a first indication IND-1 from a terminal device 10, the first indication IND-1 characterizing a failure FAIL related to a serving cell C-A of the terminal device 10.

In some embodiments, the assisting cell C-B or the distributed unit DU1 providing the assisting cell C-B, respectively, may control at least some aspects of its operation based on the received first indication IND-1, optionally also based on measurements MEAS (FIG. 5) of the terminal device 10, which, in some embodiments, may be comprised in the first indication IND-1.

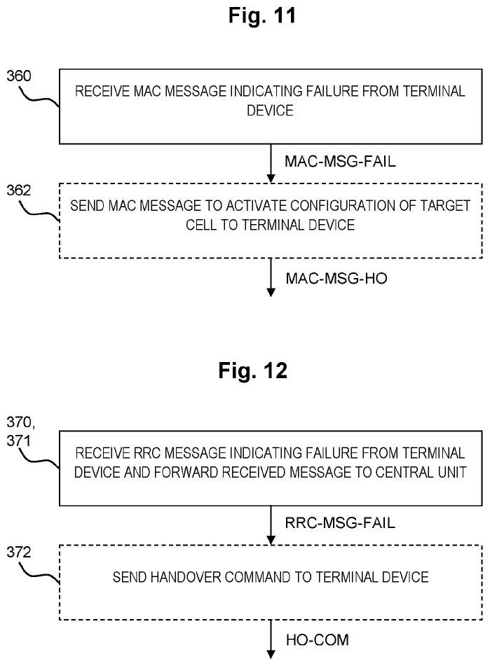

In some embodiments, FIG. 11, the instructions 206, when executed by the at least one processor 202, further cause the distributed unit DU1 to perform at least one of: a) receiving 360 a medium access control, MAC, message MAC MSG-FAIL indicating the failure FAIL from the terminal device 10, b) sending 362 a MAC message MAC-MSG-HO to activate a RRC configuration of a target cell to actuate a serving cell change to the terminal device 10.

In some embodiments, FIG. 12, the instructions 206, when executed by the at least one processor 202, further cause the distributed unit DU1 to perform at least one of: a) receiving 370 a radio resource control, RRC, message RRC-MSG-FAIL indicating the failure FAIL from the terminal device 10 and forwarding 371 the RRC message RRC-MSG-FAIL to a central unit CU associated with the serving cell C-A, b) sending 372 a, for example layer 3, handover command HO-COM, e.g. received from a central unit CU, to the terminal device 10.

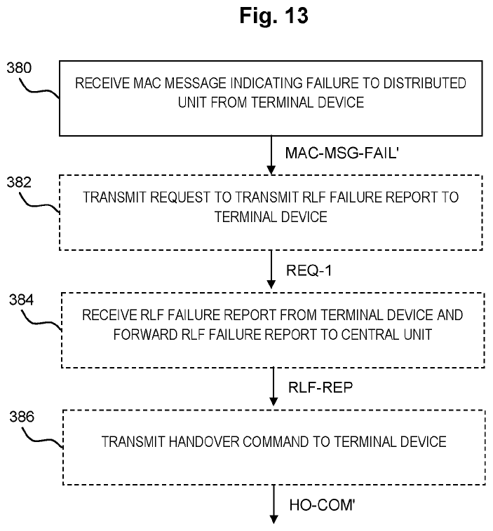

In some embodiments, FIG. 13, the instructions 206, when executed by the at least one processor 202, further cause the distributed unit DU1 to perform at least one of: a) receive 380 a MAC message indicating the failure from the terminal device, b) transmit 382 a request to the terminal device to transmit a radio link failure report, e.g. in an RRC message, c) receive 384 a radio link failure report from the terminal device and forwarding the RRC radio link failure report or at least a part thereof to a central unit, d) transmit 386 a, for example layer 3, handover command HO-COM′ received from the central unit CU to the terminal device 10.

Further exemplary embodiments, FIG. 10, relate to a method comprising: receiving 350, by a distributed unit DU1 providing an assisting cell C-B, a first indication IND-1 from a terminal device 10, the first indication IND-1 characterizing a failure FAIL related to a serving cell C-A of the terminal device 10.

Further exemplary embodiments, FIG. 16, relate to an apparatus 200′ comprising means 202′ for causing a distributed unit DU1 providing an assisting cell C-B to receive a first indication IND-1 from a terminal device 10, the first indication IND-1 characterizing a failure FAIL related to a serving cell C-A of the terminal device 10. In some embodiments, the means 202′ may comprise at least one of the components 202, 204, 206 of FIG. 2.

Further exemplary embodiments, FIG. 17, relate to an Apparatus 30, comprising at least one processor 32, and at least one memory 34 storing instructions 36, the at least one memory 34 and the instructions 36 configured to, with the at least one processor 32, cause a network device CU, DU1 (FIG. 3) to provide 390 (FIG. 19) configuration information I-CONF to a terminal device 10, the configuration information I-CONF (FIG. 6) characterizing at least one of: a) a configuration m-TRP-CONF of at least one assisting cell for multiple Transmission Reception Point, TRP, transmission/reception, b) an indication IND-a for the terminal device to enable a radio link failure recovery by sending a medium access control, MAC, message indicating a failure to a distributed unit associated with the assisting cell C-B, c) an indication IND-b for the terminal device to enable radio link failure recovery by sending a radio resource control, RRC, message indicating the failure to a central unit associated with the serving cell C-A, d) an indication IND-c for the terminal device to enable a radio link failure recovery by sending a MAC message indicating the failure to a distributed unit associated with the assisting cell C-B and an RRC message using the assisting cell radio link, indicating the failure to a central unit associated with the serving cell.

Further exemplary embodiments, FIG. 18, relate to an apparatus 30′ comprising means 32′ for causing a network device CU, DU1 to provide 390 configuration information I-CONF (see, for example, FIG. 5) to a terminal device 10.

In some embodiments, the apparatus 30 and/or the apparatus 30′ may be provide in the central unit CU and/or in at least one distributed unit DU1, DU2 (FIG. 3), e.g. of a network node, such as a gNB.

Further exemplary embodiments, FIG. 19, relate to a method, comprising: providing 390, by a network device CU, DU1, configuration information I-CONF (see, for example, FIG. 5) to a terminal device 10.

Further exemplary embodiments relate to a wireless communications system 1 (FIG. 3) comprising at least one apparatus according to the embodiments.

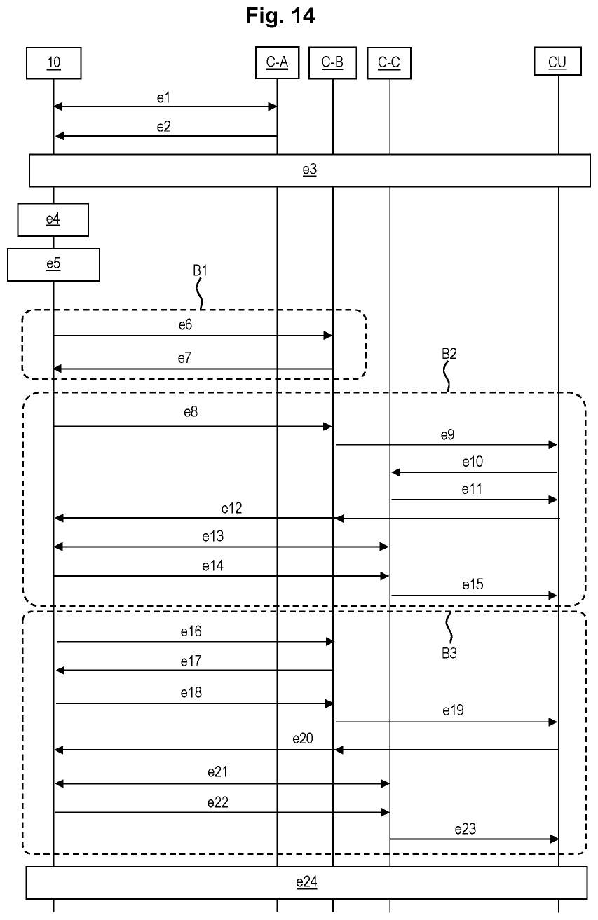

FIG. 14 schematically depicts an exemplary signalling diagram according to some embodiments. Exemplarily depicted is a user equipment (UE) 10, a first, currently serving, cell C-A associated with (i.e., provided by) a first distributed unit DU1, a second cell C-B, which is an assisting cell also associated with (i.e., provided by) the first distributed unit DU1. Also depicted is a third cell C-C, which is associated with (i.e., provided by) a second distributed unit DU2 (FIG. 3), and a central unit CU. In some embodiments, the functionality of a base station, e.g. gNB, may at least comprise the central unit CU and the distributed units DU1, DU2 as exemplarily depicted by FIG. 14.

The diagram of FIG. 14 is related to an exemplary intra-DU inter-cell scenario, in which mTRP is configured for the UE 10 involving serving cell C-A and assisting cell C-B in the same distributed unit DU1. Element e1 of FIG. 14 exemplarily symbolizes the UE 10 being connected to the currently serving cell C-A. Element e2 of FIG. 14 symbolizes the UE 10 receiving an RRC configuration (“preconfiguration”) of at least one assisting cell C-B for multi-TRP transmission/reception.

In a first case, according to some embodiments, the element e2 may include an indication for the UE 10 to enable radio link failure recovery by sending MAC CE (see element e6) indicating a serving cell RLF to the distributed unit DU1 in case the measured/selected target cell for recovery, e.g., cell C-B, is one of the mTRP assisting cells that is configured for the UE 10.

In a second case, according to some embodiments, the element e2 may include an indication for the UE 10 to enable radio link failure recovery by sending an RRC message (see element e8) with an RLF report and latest L3 measurements to the central unit CU in case the measured/selected target cell for recovery is not one of the mTRP assisting cells that are configured for the UE 10.

In a third case, according to some embodiments, the element e2 may include an indication for the UE 10 to enable radio link failure recovery by sending both MAC CE (see element e16) indicating a serving cell RLF to the distributed unit DU1 and an RRC message with an RLF indication to the central unit CU in case the measured/selected target cell for recovery is one of the mTRP assisting cells that is configured for the UE 10, but belongs to a different DU (e.g., DU2), i.e., the UE 10 can, in some embodiments, identify if the selected cell belongs to the same DU or different DU.

Element e3 symbolizes the UE 10 activating an mTRP transmission with the serving cell C-A and the assisting cell C-B. Element e4 symbolizes the UE detecting an RLF for the current serving cell C-A. Element e5 symbolizes the UE 10, optionally, skipping, i.e. omitting, a conventional re-establishment procedure according to some accepted standards. In some embodiments, element e5 may further symbolize the UE 10 measuring target cells and deciding which method to follow based on the measured/selected target cell for recovery target cell. In some embodiments, e.g. if the measured/selected target cell for recovery target cell is one of the mTRP assistant cells, the UE 10 may perform option 1 as explained further below with reference to block B1 of FIG. 14. In some embodiments, if measured/selected target cell for recovery target cell is not an mTRP assistant cell, the UE may perform option 2 or option 3 as explained further below with reference to blocks B2, B3 of FIG. 14.

In the first option, according to some embodiments, also see block B1 of FIG. 14, the UE 10 sends an UL MAC message e6 to the current assisting cell's DU, e.g. DU1 of cell C-B, e.g. to inform about the RLF on the serving cell C-A, wherein message e6 may e.g. include L1 RSRP measurements of non-serving cells (e.g., assisting cells). Subsequently, the first distributed unit DU1 may send a DL MAC CE message e7 to the UE 10, e.g. to activate a L1 handover command, provided the recently reported L1 RSRP measurements include a cell which is eligible for L1/L2 mobility, i.e. preconfiguration of the target cell is available with the UE 10.

In the second option, according to some embodiments, also see block B2 of FIG. 14, the UE 10 may send an RRC message e8 including RLF report and, optionally, the latest measurements. The distributed unit DU1 may send an F1 message e9 to the central unit CU, e.g. indicating that serving cell RLF recovery is required with the RLF report and measurements received from the UE 10. In some embodiments, the central unit may prepare a target cell, e.g. using messages e10, 11 exchanged with the third cell C-C or its distributed unit DU2 (FIG. 3), respectively, and may send a handover command e12 to the UE 10, e.g. via the assisting cell C-B, e.g. based on the measurements and the RLF report e8, e9. In some embodiments, element e10 symbolizes a UE context setup request, and element e11 characterizes a UE context setup response. In some embodiments, element e13 symbolizes a random access procedures carried out by the UE 10 at the third, i.e. target, cell C-C, and element e14 symbolizes an RRCReconfigurationComplete message according to some accepted standards. In some embodiments, element e15 symbolizes an UL RRC Message transfer message according to some accepted standards, i.e. associated with the RRCReconfigurationComplete message e14.

In the third option, according to some embodiments, also see block B3 of FIG. 14, the UE 10 may send an UL MAC CE e16 to the distributed unit DU1 (i.e., via the assisting cell C-B) to indicate serving cell RLF along with the L1 RSRP measurements. In some embodiments, the message e16 may include also the L1 measurements of non-serving cells. In some embodiments, the distributed unit DU1 may evaluate the L1-RSRP measurements e16 and may find out that none of the reported cells are controlled by it. If so, the distributed unit DU1 sends a DL MAC CE e17 to the UE 10 to send an RRC message e18 including the RLF report and, optionally, the latest L3 measurements to the central unit CU, e.g. via the distribute unit DU1, see elements e18, e19. In some embodiments, element e19 may e.g. be an UL RRC Transfer message according to some accepted standards, e.g. comprising the RLF report. Upon receiving the RRC message e18, e19 from the UE 10, the control unit CU may trigger an L3 based handover for the UE to an inter-DU target cell C-C based on the measurements indicated by UE 10, wherein element e20 e.g. symbolizes a handover command. In some embodiments, element e21 symbolizes a random access procedure carried out by the UE 10 at the third, i.e. target, cell C-C, and element e22 symbolizes an RRCReconfigurationComplete message according to some accepted standards. In some embodiments, element e23 symbolizes an UL RRC Message transfer message according to some accepted standards, i.e. associated with the RRCReconfigurationComplete message e22.

In some embodiments, e.g. alternatively to element e20, if there is a target cell belonging to the same distributed unit DU1 (e.g., preconfiguration not available with the source DU DU1), the central unit CU may also send an F1 message (not shown) to the distributed unit DU1 (e.g., via the assisting cell C-B), e.g. to trigger an L1/L2 handover for a new target cell, e.g. by including RRC delta configuration also.

In some embodiments, element e24 symbolizes an mTRP transmission, wherein cell C-C is the serving cell, and wherein cell C-B is the assisting cell.

At least some of the exemplary embodiments explained above may at least temporarily attain at least one of the following aspects or advantages: a) faster and/or slimmer failure handling/recovery than conventional re-establishment by means of L1 signaling, b) less interruption time during the recovery procedure, c) re-use of the existing reserved resources (as e.g. in Case 1).

1-18. (canceled)

19. An apparatus, comprising at least one processor, and at least one memory storing instructions, the at least one memory and the instructions configured to, with the at least one processor, cause a terminal device to detect a failure (FAIL) related to a serving cell (C-A) and to transmit a first indication (IND-1) characterizing the failure (FAIL) to a network node associated with an assisting cell (C-B).

20. The apparatus according to claim 19, wherein the instructions, when executed by the at least one processor, further cause the terminal device to: perform at least one layer 1 measurement (MEAS) related to at least one potential target cell, and to transmit the first indication (IND-1) based on the at least one layer 1 measurement (MEAS).

21. The apparatus according to claim 19, wherein the instructions, when executed by the at least one processor, further cause the terminal device to receive configuration information (I-CONF) characterizing at least one of: a) a configuration (m-TRP-CONF) of at least one assisting cell (C-B) for multiple Transmission Reception Point, TRP, transmission/reception, b) an indication (IND-a) for the terminal device to enable a link failure recovery by sending a medium access control, MAC, message (MAC-MSG-FAIL; e6) indicating the failure (FAIL) to a distributed unit (DU1) associated with the assisting cell (C-B), c) an indication (IND-b) for the terminal device to enable radio link failure recovery by sending a radio resource control, RRC, message (RRC-MSG; e8) using an assisting cell (C-B) radio link, indicating the failure (FAIL) to a central unit (CU) associated with the serving cell, d) an indication (IND-c) for the terminal device to enable a link failure recovery by sending a MAC message (MAC-MSG′; e16) indicating the failure (FAIL) to a distributed unit (DU1) associated with the assisting cell (C-B) and an RRC message (RRC-MSG′; e18) using the assisting cell (C-B) radio link, indicating the failure (FAIL) to a central unit (CU).

22. The apparatus according to claim 19, wherein the instructions, when executed by the at least one processor, further cause the terminal device to perform at least one of: a) sending a medium access control, MAC, message (MAC-MSG-FAIL; e6) indicating the failure (FAIL) to a distributed unit (DU1) associated with the assisting cell (C-B), b) receiving a MAC message (MAC-MSG-HO) to activate a RRC configuration of a target cell to actuate a layer 1 based serving cell change.

23. The apparatus according to claim 19, wherein the instructions, when executed by the at least one processor, further cause the terminal device to perform at least one of: a) sending a radio resource control, RRC, message (RRC-MSG-FAIL; e8) indicating the failure (FAIL) to a central unit (CU) associated with the serving cell (C-A) using the assisting cell radio link, b) receiving a layer 3 handover command (HO-COM) to perform handover to a target cell.

24. The apparatus according to claim 19, wherein the instructions, when executed by the at least one processor, further cause the terminal device to perform at least one of: sending a MAC message (MAC-MSG-FAIL′; e16) indicating the failure (FAIL) to a distributed unit (DU1) associated with the assisting cell (C-B), b) receiving a request (REQ-1) from the distributed unit (DU1) to transmit a radio link failure report to a central unit (CU) associated with the serving cell (C-A), c) transmitting radio link failure report (RLF-REP) to a central unit (CU), d) receiving a handover command (HO-COM′) to perform handover to a target cell.

25. An apparatus, comprising at least one processor, and at least one memory storing instructions, the at least one memory and the instructions configured to, with the at least one processor, cause a distributed unit (DU1) providing an assisting cell (C-B) to: receive a first indication (IND-1) from a terminal device, the first indication (IND-1) characterizing a failure (FAIL) related to a serving cell (C-A) of the terminal device.

26. The apparatus of claim 25, wherein the instructions, when executed by the at least one processor, further cause the distributed unit (DU1) to perform at least one of: a) receiving a medium access control, MAC, message (MAC-MSG-FAIL; e6) indicating the failure (FAIL) from the terminal device, b) sending a MAC message (MAC-MSG-HO) to activate a RRC configuration of a target cell to actuate a serving cell change to the terminal device.

27. The apparatus according to claim 25, wherein the instructions, when executed by the at least one processor, further cause the distributed unit (DU1) to perform at least one of: a) receiving a radio resource control, RRC, message (RRC-MSG-FAIL; e8) indicating the failure (FAIL) from the terminal device and forwarding the RRC message (RRC-MSG-FAIL; e9) to a central unit (CU), b) sending a layer 3 handover command (HO-COM) received from a central unit (CU) to the terminal device.

28. The apparatus according to claim 25, wherein the instructions, when executed by the at least one processor, further cause the distributed unit (DU1) to perform at least one of: a) receive a MAC message (MAC-MSG-FAIL′; e16) indicating the failure (FAIL) from the terminal device, b) transmit a request (REQ-1) to the terminal device to transmit a radio link failure report in a radio resource control, RRC, message, c) receive a radio link failure report (RLF-REP) from the terminal device and forwarding (e19) the RRC radio link failure report (RLF-REP) or at least a part thereof to a central unit (CU), d) transmit a layer 3 handover command (HO-COM′) received from the central unit (CU) to the terminal device.

29. An Apparatus, comprising at least one processor, and at least one memory storing instructions, the at least one memory and the instructions (configured to, with the at least one processor, cause a network device (CU, DU1) to provide configuration information (I-CONF) to a terminal device, the configuration information (I-CONF) characterizing at least one of: a) a configuration (m-TRP-CONF) of at least one assisting cell (C-B) for multiple Transmission Reception Point, TRP, transmission/reception, b) an indication (IND-a) for the terminal device to enable a radio link failure recovery by sending a medium access control, MAC, message (MAC-MSG-FAIL; e6) indicating a failure (FAIL) to a distributed unit (DU1) associated with the assisting cell (C-B), c) an indication (IND-b) for the terminal device to enable radio link failure recovery by sending a radio resource control, RRC, message (RRC-MSG; e8) indicating the failure (FAIL) to a central unit (CU) associated with the serving cell, d) an indication (IND-c) for the terminal device to enable a radio link failure recovery by sending a MAC message (MAC-MSG′; e16) indicating the failure (FAIL) to a distributed unit (DU1) associated with the assisting cell (C-B) and an RRC message (RRC-MSG′; e18) using the assisting cell radio link, indicating the failure (FAIL) to a central unit (CU) associated with the serving cell (C-A).
